(19) United States
(12) Patent Application Publication
(10) Pub. No.: US 2016/0339892 A1
(43) Pub. Date: Nov. 24, 2016

(54) VACUUM BRAKE BOOSTER

(71) Applicant: Robert Bosch GmbH, Stuttgart (DE)

(72) Inventor: Bruno BERTHOMIEU, Gava (FR)

(21) Appl. No.: 15/112,764

(22) PCT Filed: May 19, 2015
(86) PCT No.: PCT/EP2015/060979

§ 371 Date: Jul. 20, 2016

(30) Foreign Application Priority Data
Jun. 6, 2014 (FR) 1455161

(51) Int. Cl. B60T 17/00; B60T 13/569; B60T 13/57

(52) U.S. Cl. CPC B60T 17/008; B60T 13/57; B60T 13/569

(57) ABSTRACT

Vacuum brake booster comprising a vacuum housing subdivided by a piston into a vacuum chamber and a variable-pressure chamber for amplifiying the input force Fe and applying the output force to the master cylinder. The piston is carried by a valve body connected to the control rod by a plunger piston collaborating with the valve to command the pulling of a vacuum in the variable-pressure chamber or the venting thereof to atmosphere at the moment of braking. The air path passes via the opening through the inlet filter, the inside of the body and the passage of the sealing seat controlled by the valve to pass through the passage of the body opening between the cover and the piston into the chamber. The outlet of the passage is covered by a slowing filter.

### FIELD

The present invention concerns a vacuum brake booster comprising a vacuum housing subdivided by a piston into a vacuum chamber and a variable pressure chamber to amplify the incoming force and apply the outgoing force to master cylinder 2, the piston being carried by a valve body connected to the control rod by a plunger piston cooperating with the valve to control, on the one hand, the creation of a vacuum in the variable pressure chamber and, on the other hand, the introduction of air into this chamber during braking, based on activation of the control rod moving the plunger piston with respect to the body, the rear of the body being equipped with air-inlet openings and an inlet filter, the air path being composed of the opening in the inlet filter, the interior of the body, passage through the seal seat controlled by the valve and passage through a channel in the body that exits between the cover and the piston in the variable pressure chamber.

### BACKGROUND INFORMATION

A conventional vacuum brake booster has the disadvantage of being noisy during operation because of the sudden and rapid arrival of outside air into the variable pressure chamber at the moment of braking.

### SUMMARY

An object of the present invention is to reduce the operating noise of a vacuum brake booster as described above, to reduce operating noise for the vehicle's passenger(s) and to reduce environmental harm without degrading the brake assist characteristics.

In accordance with the present invention, an example vacuum brake booster comprises a vacuum housing subdivided by a piston into a vacuum chamber and a variable pressure chamber in order to amplify the incoming force and apply the outgoing force on the master cylinder,
wherein the piston is carried by a valve body connected to the control rod by a plunger piston cooperating with the valve of the body to control, on the one hand, the creation of a vacuum in the variable pressure chamber and, on the other hand, the introduction of air into this chamber during braking, based on actuation of the control rod moving the plunger piston with respect to the body, the rear of the body being equipped with air-inlet openings and an inlet filter, the air path being composed of the opening through the inlet filter, the interior of the body, passage through the seal seat controlled by the valve, and passage through a channel in the body that exits between the cover and the piston in the variable pressure chamber, this vacuum brake booster being characterized in that the outlet of the body channel into the inlet of the variable pressure chamber is covered by a reducer filter, which slows the air flow entering the variable pressure chamber.

The example vacuum brake booster according to the present invention has the advantage of being very silent in operation without any perceptible whistling because of the slowdown of air reaching the variable pressure chamber during a braking action, when the valve throttle controlling the air feed to the variable pressure chamber is opened.

The reducer filter in the air path does indeed reduce the instantaneous velocity of the air entering the variable pressure chamber but this slowdown does not degrade the characteristics of the vacuum brake booster because it occurs over a very brief portion of the braking phase. Moreover, this action in the vacuum brake booster does not affect the braking systems downstream of the master cylinder. Realization of the present invention is especially simple given that it does not alter the vacuum brake booster production line.

According to another advantageous characteristic, the reducer filter is a permeable foam such as an open-cell polyurethane foam.

According to another characteristic, the reducer filter is glued to the body of the valve above the channel outlet. According to another characteristic, the reducer filter is glued to the body of the valve above the channel outlet. According to another characteristic, the filter is a foam collar that engages with the body of the valve. The elasticity of the material of the collar forming the filter ensures that the filter will remain in place on the valve body. The benefit of this embodiment is that it allows for very simple assembly.

The operations of assembling the vacuum brake booster according to the present invention remain practically unchanged by the presence of the reducer filter and its installation at the time of assembly.

### BRIEF DESCRIPTION OF THE DRAWINGS

The present invention is described in greater detail by means of an embodiment of a vacuum brake booster, shown in the attached figures.

FIG. 1 is an axial cutaway of the brake booster assembly according to the present invention.

FIG. 2 is an axial cutaway showing an enlarged detail of the body of the valve bearing the piston and the various components.

### DETAILED DESCRIPTION OF EXAMPLE EMBODIMENTS

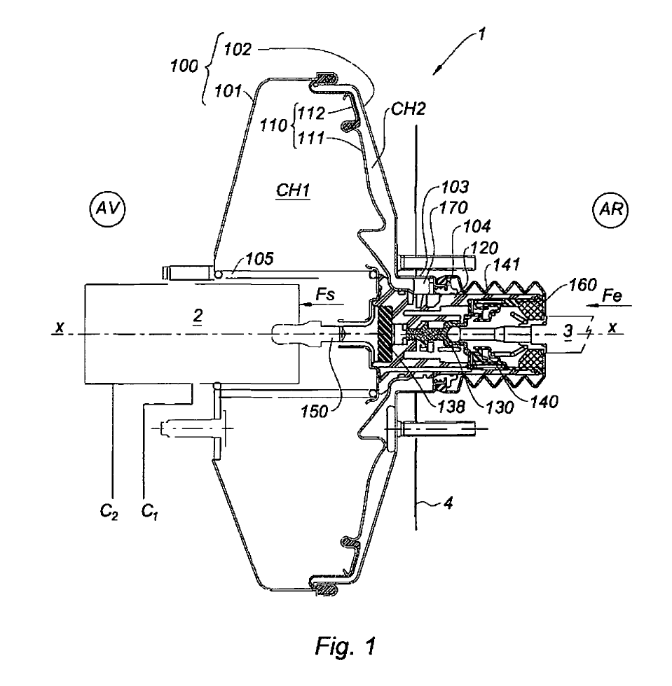

As shown by FIG. 1, the vacuum brake booster is associated with master cylinder 2, that is, a tandem master cylinder shown schematically, which supplies pressurized brake fluid to the vehicle's brake line(s) C1, C2. It is attached to firewall 4 separating the passenger compartment from the engine compartment.

By convention, master cylinder 2 is located in front (AV) of brake booster 1 and control rod 3 is in the rear (AR).

Vacuum brake booster 1 is actuated by control rod 3, connected to the brake pedal. Brake booster 1 consists of vacuum housing 100, with two chambers CH1, CH2. Chamber CH1 is a vacuum chamber (P₁<Patm) and connected to a vacuum source, and rear chamber CH2 is a vacuum/pressure chamber, separated from chamber CH1 by piston 110. Chamber CH1 is referred to as a vacuum chamber and chamber CH2 as a variable pressure chamber. The admission of air at atmospheric pressure, Patm, is controlled by the brake pedal, which acts through control rod 3 upon an air intake valve described below. Piston 110 is connected to master cylinder 2 to control it in the sense of pressurizing the brake fluid by a thrust engendered by the pressure differential applied to piston 110 between the vacuum in front chamber CH1 and the pressure found in rear chamber CH2; rear chamber CH2 is under vacuum at rest whenever the brake booster is not activated; it fills with air to reach atmospheric pressure, Patm, at the time of braking.

In general, front chamber CH1 has a relative vacuum created by the vacuum source connected to this front chamber AV, and rear chamber CH2, has a vacuum pressure like chamber CH1 when the brake booster is not activated but the vacuum source (motor) is operating. At rest, rear chamber CH2 communicates with front chamber CH1 and is at the same vacuum level.

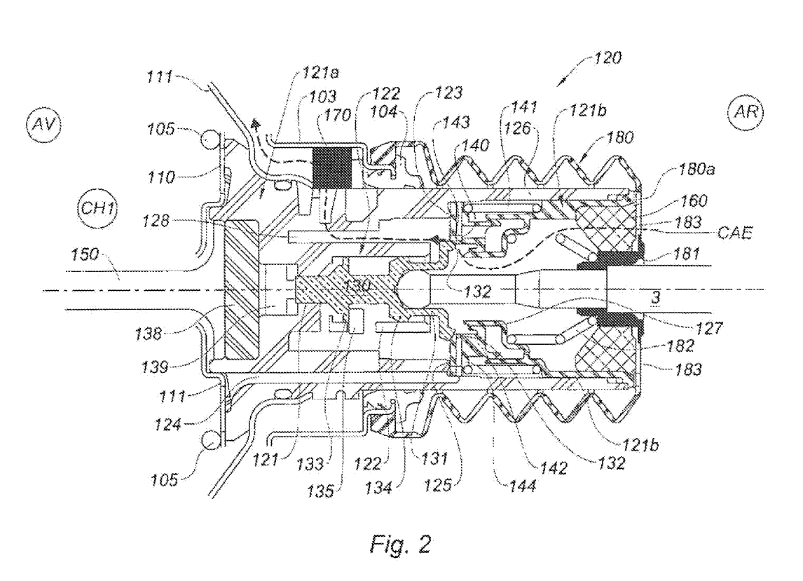

In more detailed manner, as shown by FIGS. 1 and 2, vacuum brake booster 1 consists of sheet-metal housing 100, formed by cylinder 101 connected to cover 102, the assembly shape being one of revolution about axis XX, whose sectional contour can be compared to a polygon or an ellipse. Housing 100 is subdivided by piston 110.

Piston 110, formed by central skirt 111 connected to the exterior contour of housing 100 at the assembly line of cylinder 101 and cover 102 by diaphragm 112, enables the movement of piston 110 inside housing 100, depending on the pressure existing in the two chambers and creating thrust for the brake booster.

In the center, following axis XX, which is, in a way, an axis of rotational symmetry, housing 100 accommodates valve body 120 of complex form and with multiple functions.

Valve body 120 has skirt 111 and slides in leakproof manner in rear seal 104, forming a slide bearing carried by the opening of extension 103 of cover 102. Piston 110 serves to transmit to master cylinder 2 the thrust (input force), Fe, exerted on the brake pedal and amplified by brake booster 1.

The input force, Fe, exerted is amplified to provide an output force, Fs, equal to the pressure difference, ΔP=(P2−P1), multiplied by the cross-section of piston 110 of brake booster 1 and transmitted to master cylinder 2. The result is a pressure difference created between pressure P1 of front chamber CH1 and pressure P2 of rear chamber CH2, both of which are initially under vacuum, created by the admission of air, controlled in the annular volume formed at the outlet of the channel in extension 103 of cover 102. Skirt 111 carries air filter 170, which slows the incoming air flow to this annular volume and, thus, to rear chamber CH2, when the air-intake valve is open. The exterior air path, CAE, entering rear chamber CH2 when the intake valve is opened is schematically represented by a dashed line.

In more detailed manner, the body of valve 120 operates like a piston between control rod 3 and pushrod 150. Body 120 consists of front portion 120a, integral with piston 110, and rear portion 120b, affixed to front portion 120a at the conclusion of the assembly of body 120 and the components it accommodates. It controls the creation of a vacuum in chamber CH2 or its filling and also directly transmits input force Fe to master cylinder 2 if brake booster 1 fails. Front portion 120a, houses, along axis XX, plunger piston 130, which accommodates, in the rear, the head of control rod 3, while moving integrally with it; in front, it is engaged in bearing 121 of body 120 to act upon reaction disk 138 by means of insert 139. Reaction disk 138 is itself applied to the rear of pushrod 150, integral with the input piston or primary piston of master cylinder 2.

Plunger piston 130, guided in cylinder 122 of front portion 120a, has crown 131, which extends beyond the rear of cylinder 122 and forms seal seat 132 for the air-inlet valve in rear chamber CH2. Plunger piston 130 is guided in cylinder 122 by two guide flanges 133, 134, separated by an interval, accommodating key 135, carried by portion 120a and defining the travel of plunger piston 130 with respect to cylinder 122 and, thus, to body 120.

Additionally, for reasons of construction, plunger piston 130 is housed in cylinder 122 of body 120 around axis XX, while being retained there by key 135, which is carried by body 120 and which limits the return movement of piston 130 in body 120 with which it remains integrally connected while being free in translation along the path of travel necessary for the operation of the brake booster.

Body 120 is pushed into rest position, rearward (AR), by return spring 105 housed in front chamber CH1 of housing 100 around axis XX.

Front portion 120a of body 120 accommodates valve 140 retained by rear portion 120b through the interposition of helical spring 141. Rear portion 120b, of cylindrical form, entering sleeve 126 in the rear extremity of portion 120a and being integral with it, realizes guide cylinder 127 by means of a double crown for piston 142 of annularly shaped valve 140, whose outer edge is supported by spring 141.

Valve 140 forms throttle 143 for the admission of air into chamber CH2 and throttle 144 for enabling communication between the two chambers CH1, CH2. Valve 140 makes contact with interior shoulder 123 of front portion 120a.

Channel 124 exits in the front of body 120 beyond skirt 111 and thus communicates with chamber CH1, whereas in the rear, channel 124 exits in shoulder 123, there forming seal seat 125, which cooperates with throttle 144 of valve 140.

Thus, by means of its throttles 143, 144, valve 140 cooperates with its two seal seats 132, 125, which control two air passages:
air-admission seat 132 through passage 128 in rear chamber CH2
a communications seat between front chamber CH1 and rear chamber CH2.

Thus, valve 140 serves two functions:
that of air-inlet throttle 143 in rear chamber CH2,
that of communication throttle 144 between front chamber CH1 and rear chamber CH2.

The admission of air into rear chamber CH2 controls the amplification of the incoming force, Fe, to provide the outgoing force, Fs. Communication between front chamber CH1 and rear chamber CH2 is used to create a pressure drop in rear chamber CH2 based on front chamber CH1 so that piston 110 returns to its rest position (no braking)

Front chamber CH1 is connected to a vacuum source that keeps the front chamber naturally under vacuum (pressure P1) for as long as the brake system is in operation, for example, for as long as the vehicle's motor is operating.

Valve 140 is pushed against its two seats 125 by return spring 141 resting on rear portion 120b.

Body 120 has bellows 180 attached to extension 103 above rear seal 104 and behind portion 121b to close body 120 while allowing control rod 3 to pass through bearing 181, also supported by helical spring 182, which presses against rear portion 121b. Back 180a of the bellows has openings 183 in front of filter 160 to allow air to enter.

The opening of the two throttles, communication throttle 144 between front chamber CH1 and rear chamber CH2, and throttle 143, which enables rear chamber CH2 to come to atmospheric pressure, results from the relative movement along axis XX between:
plunger piston 130, integral with control rod 3
body 120 pushed by plunger piston 130, and pneumatic piston 110
the movement of retaining valve 140 by shoulder 123, and by the seat of plunger piston 130, which, at a given moment, is the most rearward seat in the braking movement, which consists of initiating braking, amplifying the braking force with the brake booster, maintaining braking force, and, finally, debraking.

The air-inlet path, CAE, into rear chamber CH2 comprises the entrance of air through openings 183, passage through inlet filter 160, then through rear portion 120b, and, finally, the passage between seat 132 and throttle 143, and finally, channel 128 in portion 120a, to exit into the free space between bearing 103 of the cover and the fastener of skirt 111 through reducing filter 170 supported by body 120 (front portion 120a) of the outlet of channel 128. Filter 170 occupies the entire interval between portion 121a and extension 103 to slow the incoming air flow and reduce noise.

Reducer filter 170 is, preferably, an open-cell foam such as a polyurethane foam. The filter may be, for example, glued to the body of the valve or present in the form of a collar elastically adjusted to the body of the valve on which it is fitted. Under these conditions, installation of the filter is very simple.

Filter 170 is installed on body 120 after it is assembled with piston 110 by its skirt 111 and before this assembly is installed in housing 100.

1-4. (canceled)

5. A vacuum brake booster, comprising:
a vacuum housing subdivided by a piston into a vacuum chamber and a variable pressure chamber in order to amplify an incoming force and apply an outgoing force to a master cylinder;
wherein the piston is carried by a valve body connected to a control rod by a plunger piston cooperating with a valve of the valve body to control: i) a vacuum in the variable pressure chamber, and ii) an introduction of air into the variable pressure chamber during braking based on actuation of the control rod moving the plunger piston with respect to the valve body, a rear of the valve body being equipped with air-inlet openings and an inlet filter; and
wherein an air path includes an opening through the inlet filter, through an interior of the valve body and a seal seat passage controlled by the valve, and passage through a channel in the valve body, exiting between a cover and the piston in the variable pressure chamber, an outlet of the channel in the valve body into an inlet of the variable pressure chamber is covered by a reducer filter, which slows air flow into the variable pressure chamber.

6. The vacuum brake booster according to claim 5, wherein the filter is made from a permeable foam such as an open-cell polyurethane foam.

7. The vacuum brake booster according to claim 6, wherein the permeable foam is an open-cell polyurethane foam.

8. The vacuum brake booster according to claim 5, wherein the reducer filter is attached to the valve body above the outlet of the channel by gluing.

9. The vacuum brake booster according to claim 5, wherein the reducer filter is a foam collar installed on the body of the valve.
